(19) United States
(12) Patent Application Publication
(10) Pub. No.: US 2005/0230590 A1
(43) Pub. Date: Oct. 20, 2005

(54) Flat panel display ceiling mount

(76) Inventor: Charles Westbrook, San Carlos, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/827,761

(22) Filed: Apr. 19, 2004

(51) Int. Cl. G09G 3/28

(52) U.S. Cl. 248/327

(57) ABSTRACT

A system for suspending a flat panel display from a ceiling is described. The system comprises a base mountable on the ceiling, a column suspended from the base along a vertical axis, and a panel attachment plate pivotally connected to the column and attachable to the back portion of the flat panel display. The system permits rotation of the column about the vertical axis and pivoting of the panel attachment plate about a horizontal axis.

### BACKGROUND OF THE INVENTION

1. Field of the Invention

The present invention relates generally to systems for mounting objects to a ceiling, and more particularly to a system for mounting a flat panel display to a ceiling that allows the orientation of the panel to be adjusted.

2. Description of the Background Art

The introduction of flat panel displays in recent years has dramatically reduced the amount of space needed for display devices. Compared to a standard television or monitor, a flat panel display of equal screen size is significantly lighter and smaller and can easily be incorporated into a small workspace. Flat panel displays typically require a stand or other mounting system to be positioned for convenient viewing. For example, they can be mounted on desks, counters, shelves, or floors with mounting stands of varying sizes and shapes. In addition, the slim design of flat panel displays allows them to be easily mounted on a wall or on the side of a large fixture.

Although flat panel displays are considerably smaller than standard monitors or televisions, they still occupy valuable workspace. Workspace can come at a premium in crowded work environments such as in a hospital, tavern, or airport. Therefore, it is desirable to have a mounting system that frees up the valuable workspace occupied by mounting stands. Although mounting a flat panel display on a wall may free up workspace, wall mount systems have their disadvantages. Most notably, there may not always be a wall available to mount a flat panel display for convenient viewing, and the number of viewing orientations achievable with a wall mounted display is limited. Therefore, it is desirable to have a flat panel display mounting system that occupies no workspace and that can be easily adjusted for multiple viewing angles.

### BRIEF SUMMARY OF THE INVENTION

The present invention overcomes the problems of the prior art by providing a ceiling mount system that allows the orientation of the a flat panel display to be adjusted for multiple viewing angles. The system comprises a base mountable on a ceiling, a column vertically suspended from the base, and a panel attachment plate pivotally connected to the column and attachable to the back portion of a flat panel display. The column is rotatably connected to the base to allow rotation of column about a vertical axis, preferably through a full 360°, thus allowing the panel to face in virtually any desired direction. The panel attachment plate is pivotally connected to the column to allow the panel to pivot about a horizontal axis to further permit adjustment to different viewing angles.

In one aspect of the invention, the base of the ceiling mount system comprises one or more bracket(s) mountable to a ceiling and a column support plate engageable with the bracket(s). The bracket has grooves along it's edges to slidably receive wrapping edges of the column support plate. The column support plate can optionally be secured to the bracket(s) with blocks that prevent the support plate from sliding off the bracket.

In another aspect of the invention, the panel attachment plate comprises a flange surrounding a convex or spherical surface. The convex or spherical surface is received by a circular socket formed in the lower portion of the column. A positioning mechanism for retaining the panel attachment plate within the socket is provided which allows a wide range of orientations for the panel attachment plate to be selected and maintained. For example, the panel attachment plate is capable of tilting within the socket on the convex surface.

### BRIEF DESCRIPTION OF THE DRAWINGS

FIG. 1 is a perspective rear view of one embodiment of the ceiling mount system in combination with a ceiling and a flat panel display.

FIG. 2 is a front view of one embodiment of the ceiling mount system.

FIG. 3 is a side cross-sectional view taken along line A--A of FIG. 2.

FIG. 4 is a perspective view illustrating the panel attachment plate and the retaining plate of one embodiment of the ceiling mount system.

FIG. 5 is a cross-sectional view of the removable panel attachment plate mounted on the retaining plate of one embodiment of the ceiling mount system.

FIGS. 6 and 7 illustrate an alternative ceiling mount including rollers.

### DETAILED DESCRIPTION OF THE INVENTION

In the following description, for purposes of explanation, numerous details are set forth in order to provide a thorough understanding of the present invention. However, it will be apparent to one skilled in the art that these specific details are not required to practice the present invention.

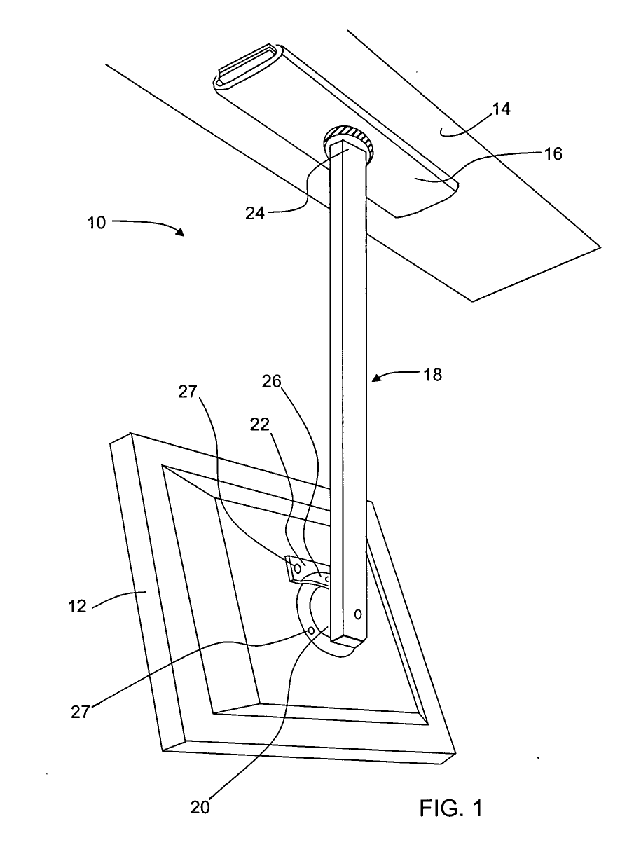

Referring to FIG. 1, an exemplary system 10 for mounting a flat panel display 12 to a ceiling 14 is illustrated. The system 10 comprises a base 16, a column 18, a panel attachment plate 20, and a retaining plate 22. The base 16 is mounted to the ceiling 14, and the column 18 is vertically suspended from the base 16. An upper end 24 of column 18 is rotatably connected to the base 16 allowing the column 18 to rotate about its vertical axis. The panel attachment plate 20 is pivotally connected to the lower portion of column 18 allowing the panel attachment plate 20 to pivot about a horizontal axis. The flat panel display 12 is supported by the system 10 via both the panel attachment plate 20 and the retaining plate 22. The retaining plate 22 is attached to the back portion of panel 12 by any suitable means, e.g., by a plurality of fasteners 27, although adhesives, laminate structures, and the like could also find use. The retaining plate 22 includes a lip 26 that can receive a portion of the panel attachment plate 20 allowing the display 12 to hang from the system 10. In addition, the panel 12 may be further secured to the system 10 by being attached to the panel attachment plate 20 by the plurality of fasteners 27. It will be appreciated that the panel attachment plate 20 could be removably secured to panel 12 by a variety of know mechanical attachment mechanisms.

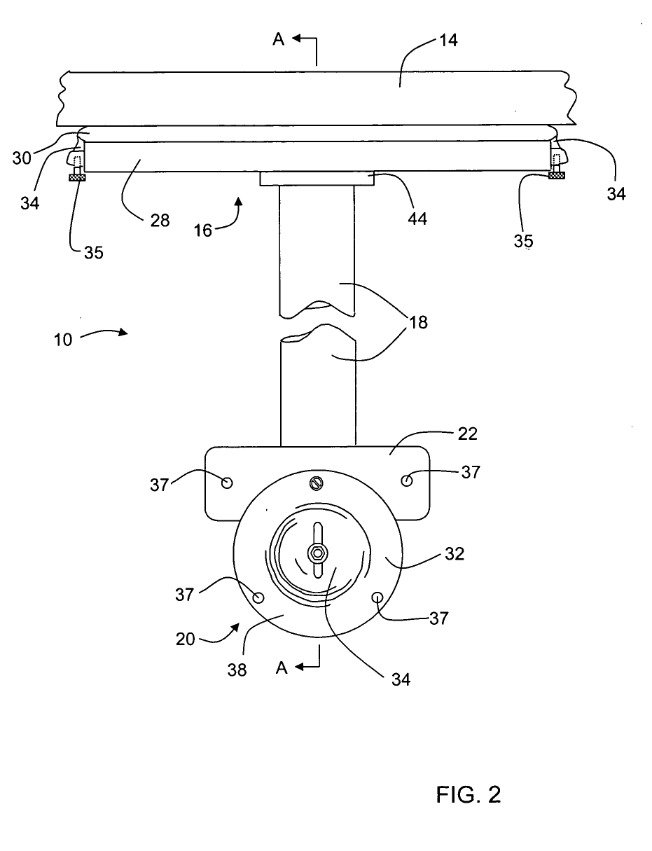

Referring now to FIG. 2, a front view of the system 10 is illustrated absent the flat panel display 12. The base 16, column 18, panel attachment plate 20, and retaining plate 22 are shown. The base 16 comprises a column support plate 28 and a bracket 30 mounted to the ceiling 14 with a plurality of fasteners (not shown). The panel attachment plate 20 has a flange 32 surrounding a convex spherical surface 34, the inner side of which is shown in FIG. 2. Both the panel attachment plate 20 and the retaining plate 22 have holes 38 to receive fasteners 27 (FIG. 1) that attach the plates 20 and 22 to the flat panel display 12. In one embodiment, the column 18 has a flange 36 to provide lateral support to column 18 when the system 10 is being manipulated. It will be understood that the flange 36 can either be integrally formed with, bonded to, or detachably connected to the column 18.

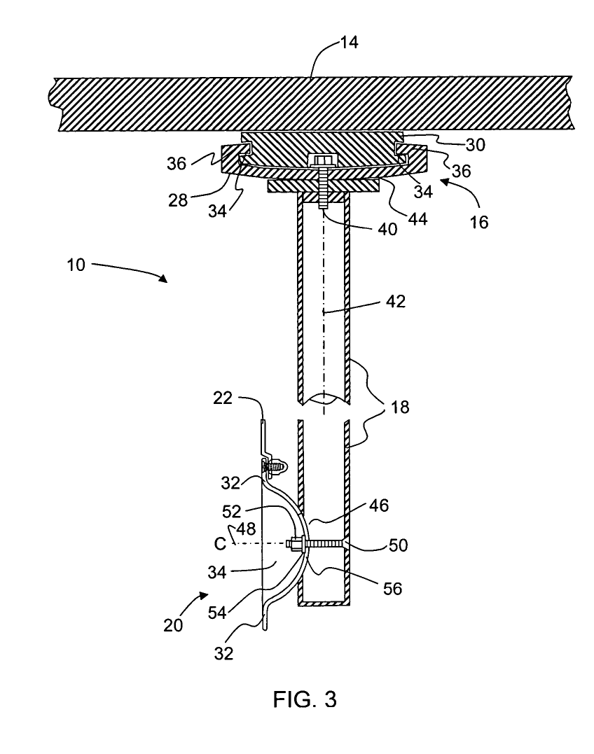

Referring still to FIG. 2, the base 16 comprises the column support plate 28 and the bracket 30. The bracket 30 has two long and narrow sides, each of which has a groove 34 disposed along its length. The column support plate 28 has wrapping edges 36 (shown in FIG. 3) that are received by the grooves 34. The column support plate 28 is connected to the bracket 30 by being slid horizontally over the bracket such that the wrapping edges 36 slidably engage the grooves 34. Once the column support plate 28 is engaged with the bracket 30, it will cover at least a portion of bracket hiding it from view.

In the illustrated embodiment, the column support plate 28 is secured to the bracket 30 by a friction fit between the wrapping edges 36 and the grooves 34. In addition, stops 35 can be secured at both ends of the bracket 30 to prevent the column support plate 28 from sliding off from bracket 30. The stops 35 can have threaded ends that engage corresponding threaded holes of the bracket 30 (not shown). Alternatively, one or more fasteners (not shown) can be used to directly secure the column support plate 28 to the bracket 30. Alternatively, the bracket 30 can be divided into separate top and bottom halves (not shown). The distance between the two halves can be adjusted such that the widths of the grooves 34 can be increased or decreased. This adjustment will increase or decrease the strength of the friction fit securing the column support plate 28 to the bracket 30.

In another embodiment, bracket 30 is divided up into a plurality of brackets (not shown). If the base 16 is mounted to the ceiling 14 perpendicular to the joists of ceiling 14, each bracket of the plurality of brackets can be secured to a separate joist of ceiling 14 to allow for greater support of the system 10.

FIG. 3 is a side cross-sectional view of the system 10. The base 16, column 18, panel attachment plate 20, and retaining plate 22 are shown. The column support plate 28 is shown engaged with the bracket 30. The wrapping edges 36 of the column support plate 28 are wrapped around the bottom portion of the bracket 30 and are received by the grooves 34 such that the plate 28 is hanging from bracket 30. The column 18 is rotatably connected to the column support plate by a bolt 40. The bolt 40 is received by a shaft centrally located on the plate 28 and engages internally threaded portions of both the flange 36 and the column 18. It will be understood that either or both of the column 18 and flange 36 can be threaded. The bolt 30 allows the column 18 to rotate about a vertical axis 42. During rotation of the column 18, the bolt 40 can rotate freely within the shaft of the plate 28 while remaining fixed within column 18 and flange 36.

In one embodiment, the system 10 further comprises a lubricous washer 44, made from nylon or another lubricous material, disposed between the upper end of column 18 and the column support plate 28. The lubricous washer 44 lubricates the rotation of the column 18 about the axis 42. Alternatively, or additionally, the lubricous material can be disposed underneath the head of bolt 40 to lubricate the rotation of the column 18 about the axis 42.

Referring still to FIG. 3, the convex surface of the panel attachment plate 20 is received in a circular socket 46 formed within the lower portion of the column 18. Thus, without any further attachment, the panel attachment plate 20 would be able to both rotate and tilt within the socket 46 on the convex spherical surface. Rotation is considered to be a circular motion about an axis 48, while tilting is a motion about any horizontal axis which passes through a center C of the convex surface 34. A positioning mechanism for retaining the panel attachment plate 20 within the socket 46 is provided which allows a wide range of orientations for the panel attachment plate 20 to be selected and maintained. The positioning mechanism for securing the panel attachment plate 20 to the column 18 comprises a bolt 50, a nut 52, and a washer 54. The bolt is received through the rear side of the column 18 and projects therefrom through a slot 56 formed within the convex surface 46.

FIG. 3A illustrates an alternative configuration for attaching the column 18 to the support plate 28 via bracket 30. Bolt 40 is threadably attached to a block 70 which is axially slidable within the interior 72 of column 18. A spring 74 resiliently extends the block 70 relative to the bolt 40 and bracket 30, thus providing a flexible column joint.

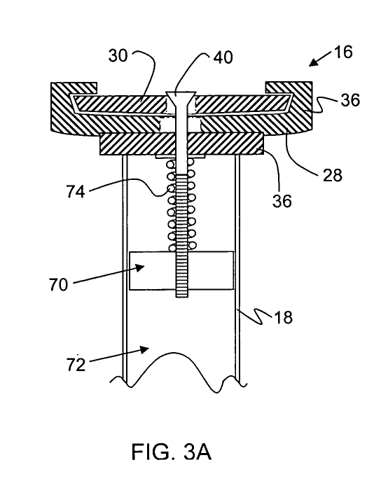

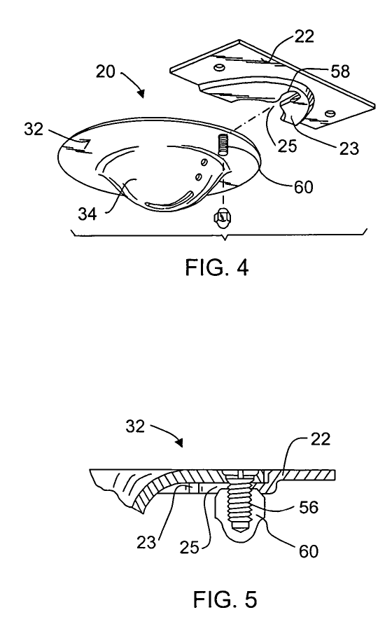

Referring now to FIGS. 4 and 5, the panel attachment plate 20 has the flange 32 surrounding the convex surface 34. The flange 32 defines a substantially flat support surface for the flat panel display 12.

To secure the panel 12 to the flange 32, the retaining plate 22 is attached to the rear portion of the panel 12, as illustrated in FIG. 1, by fasteners 27 (FIG. 5). The plate 22 includes a semi-circular depression 23 having dimensions so that the flange 32 on the panel attachment plate 20 can be inserted into the space defined by the depression 23 and the rear portion of the panel 12. A slot 25 is formed in the edge of the depression 23 and located to receive a post 56 (FIG. 5) which projects downward from the flange 32. A detent 58 is formed around the slot 25 so that a nut 60, which is threadably received on post 56, is received by the detent 58 when the retaining plate 22 is mounted on the flange 32. In this way, the panel 12 can be securely attached to the panel attachment plate 20 merely by placing the retaining plate 22 over the flange 32 and tightening the nut 60. If desired, panel 12 can be further secured to system 10 by attaching the panel attachment plate 20 the back portion of the panel 12 with fasteners 27 (FIG. 1). Fasteners 27 can be threaded and engage both the holes 38 of the panel attachment plate 20 and corresponding threads (not shown) disposed within the back portion of panel 12.

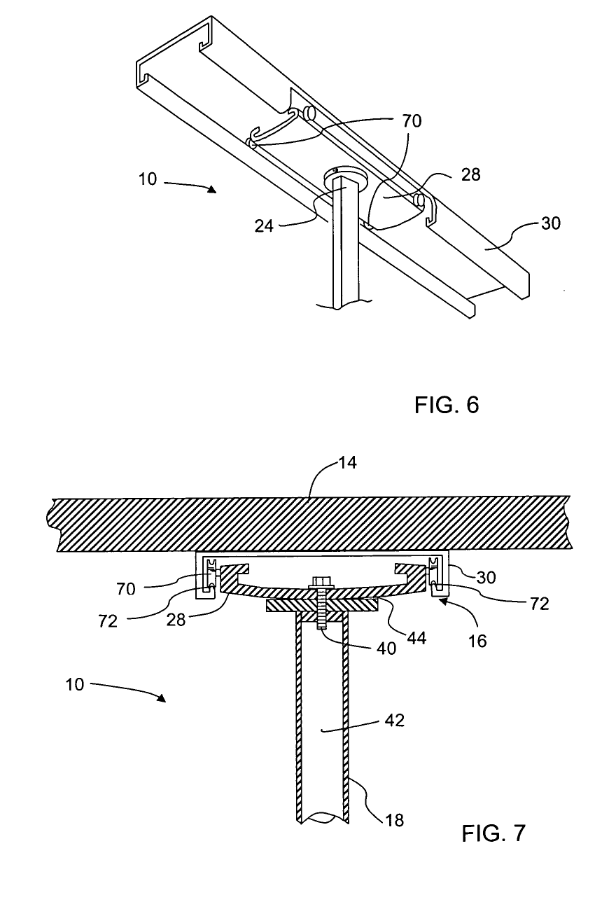

The support plate 28 can also be mounted in a channel-type bracket 30 using rollers 70, as illustrated in FIGS. 6 and 7. The rollers are received on tracks 72 to allow free translation of the plate 28 along the axis of the bracket 30. A mechanism (not shown) for locking the support plate 28 relative to the bracket 0 at a desired location will also be provided.

While this invention has been described with reference to illustrative embodiments, it will be appreciated that variations and modifications may be made, which are apparent to persons skilled in the art, without departing from what is regarded to be the subject matter of the present invention.

1. A system for suspending a flat panel display from a ceiling, the system comprising:
a base mountable on the ceiling;
a column having an upper end and a lower portion, the upper end of the column rotatably connectable to the base to permit suspension on a vertical axis and rotation of the column about the vertical axis; and
a panel attachment plate pivotally connected to the lower portion of the column to pivot about a horizontal axis.

2. The system of claim 1, wherein the base comprises:
at least one bracket mountable to the ceiling, the bracket having front and rear edges, each edge having a groove disposed along a length of the edge; and
a column support plate slidably receivable in the grooves of the bracket.

3. The system of claim 2, wherein the base further comprises a plurality of brackets, each bracket of the plurality being mountable to a separate joist of the ceiling.

4. The system of claim 2, wherein the column support plate is secured to the bracket by a friction fit.

5. The system of claim 4, wherein the strength of the friction fit is adjustable by adjusting the width of the grooves of the bracket.

6. The system of claim 2, further comprising detachable blocks to obstruct the sliding of the column support plate.

7. The system of claim 1, wherein the base has a central aperture, and the upper end of the column is rotatably connected to the base by a fastener that engages both the upper end of the column and the central aperture.

8. The system of claim 1, further comprising a lubricous material disposed between the base and the upper end of the column to lubricate the horizontal rotation of the column.

9. The system of claim 8, wherein the lubricous material is a nylon washer.

10. The system of claim 1, wherein the upper end of the column has a flange.

11. The system of claim 1, wherein the panel attachment plate comprises a flange surrounding a convex surface.

12. The system of claim 11, further comprising a retaining plate having a semi-circular lip forming a depression complementing the flange of the panel attachment plate, the retaining plate attachable to the flat panel display and the flange insertable into the depression of the retaining plate.

13. The system of claim 11, wherein at least a portion of the convex surface of the panel attachment plate is received within a socket of the column such that the panel attachment plate is simultaneously capable of rotating about an axis which is substantially perpendicular to the column and pivoting about the horizontal axis.

14. The system of claim 13, wherein the panel attachment plate is attached to the column with a nut, bolt and spring assembly, the bolt engages the lower portion of the column and a slot in the center of the convex surface of the mounting plate, the nut and spring resiliently secure the mounting plate to the lower portion of the column.

15. A method for suspending a flat panel display from a ceiling, the method comprising:
mounting a base on the ceiling;
suspending a column from the base such that the column can rotate about a vertical axis; and
mounting the flat panel display on a panel attachment plate pivotally connected to a lower portion of the column to permit pivoting of the flat panel display about a horizontal axis.

16. The method of claim 15, further comprising:
attaching a retaining plate to the flat panel display, the retaining plate having a semi-circular lip forming a depression complementing a flange of the panel attachment plate; and
hanging the flat panel display on the panel attachment plate by inserting flange into the depression of the retaining plate.

17. The method of claim 15, wherein mounting the base on the ceiling comprises:
mounting a bracket on the ceiling, the bracket having front and rear edges, each edge having a groove disposed along the length of the edge; and
slidably positioning a column support plate in the grooves of the bracket.

18. The method of claim 17, wherein the column support plate engages the bracket with a friction fit.

19. The method of claim 17, further comprising blocking the ends of the bracket to obstruct sliding of the column support plate relative to the bracket.

20. The method of claim 15, further comprising disposing a lubricous material between the column and the base.

21. A system for suspending a flat panel display from a ceiling comprising:
means for providing a base on the ceiling;
means for vertically suspending a column from the base;
means for allowing the column to rotate horizontally;
means for attaching the flat panel display to the column; and
means for allowing the flat panel display to pivot about a horizontal axis.
